(19) United States
(12) Patent Application Publication
(10) Pub. No.: US 2009/0044542 A1
(43) Pub. Date: Feb. 19, 2009

(54) APPARATUS AND METHOD FOR MONITORING COMPRESSOR CLEARANCE AND CONTROLLING A GAS TURBINE

(75) Inventors: Robert Thomas Thatcher, Greer, SC (US); Samuel David Draper, Greenville, SC (US); Erin Kelly Bauknight, JR., Seneca, SC (US); Harold Lamar Jordan, JR., Greenville, SC (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 11/840,369

(22) Filed: Aug. 17, 2007

(51) Int. Cl. F02C 9/00; F01D 21/00; F01D 7/02

(52) U.S. Cl. 60/773; 60/793; 415/118; 415/129

(57) ABSTRACT

A gas turbine including a compressor, the gas turbine including a sensor for measuring a clearance of blades in the compressor; and a controller for receiving clearance information and using the information to control the gas turbine for prevention of at least one of a surge and rubbing of the blades.

### BACKGROUND OF THE INVENTION

1. Field of the Invention

The invention disclosed herein relates to the field of gas turbines and, in particular, to increasing the efficiency of the gas turbines.

2. Description of the Related Art

A gas turbine includes many parts, each of which may expand or contract as operational conditions change. The gas turbine includes a compressor, which compresses air for combustion in a combustion chamber. The compressor uses compressor blades for compressing the air.

The compressor blades are generally shaped as airfoils. The compressor blades rotate within a casing, which has a circular shape. As the compressor blades rotate, the compressor blades use their airfoil shape to compress the air within the casing. The compressor blades and the casing are used to contain the compressed air.

The distance between the outside tip of the compressor blade and the casing is referred to as “clearance.” As the clearance increases, efficiency of the compressor decreases because of increased mixing losses associated with more air escaping across the tip of the blade. Therefore, too much clearance can lead to a decrease in overall efficiency of the gas turbine. In addition, depending on operating conditions, too much clearance can cause the compressor to surge. Too little clearance can also cause problems.

If the clearance is too small, then thermal expansion and contraction and dynamic changes of the compressor blades, the casing, and other components can cause the compressor blades to rub against the casing. When the compressor blades rub the casing, damage to the whole gas turbine can occur. It is important, therefore, to maintain a proper amount of clearance during a variety of operational conditions.

In the prior art, to maintain the proper amount of clearance, a detailed analysis and testing are generally performed. The analysis and testing are used to establish clearance targets during “cold” build-up of the gas turbine. The clearance targets must accommodate manufacturing tolerances and a variety of operational conditions such as start-up, shut-down, full power, and part power. Because of the need to accommodate the tolerances and operational conditions, the clearance targets may lead to inefficiency during certain modes of operation. For example, a time duration for start-up may have to be long enough to ensure proper heating of the compressor to preclude rubbing.

Therefore, what are needed are techniques to monitor the clearance between the compressor blades and the casing during different modes of operation. Further, the techniques should provide for controlling the gas turbine with respect to the clearance.

### BRIEF DESCRIPTION OF THE INVENTION

Disclosed is a gas turbine including a compressor, the gas turbine including a sensor for measuring a clearance of blades in the compressor; and a controller for receiving clearance information and using the information to control the gas turbine for prevention of at least one of a surge and rubbing of the blades.

Also disclosed is a gas turbine including a compressor, the gas turbine including a plurality of sensors for measuring clearances of blades in the compressor; and a controller for receiving clearance information and using the information to control at least one of fuel flow to the gas turbine and inlet bleed-heat air to the compressor for prevention of at least one of a surge and rubbing of the blades.

Also disclosed is a method for controlling a gas turbine including a compressor, the method including receiving information related to a clearance of blades in the compressor; and controlling the gas turbine to prevent at least one of a surge and rubbing of the blades.

### BRIEF DESCRIPTION OF THE DRAWINGS

FIG. 1 illustrates an exemplary embodiment of a gas turbine;

FIG. 2 illustrates an end view of an exemplary embodiment of a compressor stage;

FIG. 3 illustrates a side view of an exemplary embodiment of the compressor;

FIG. 4 illustrates an exemplary embodiment of a control system for the gas turbine; and

FIG. 5 presents an exemplary method for controlling the gas turbine.

### DETAILED DESCRIPTION OF THE INVENTION

The teachings provide embodiments of apparatus and methods for monitoring a clearance between a plurality of compressor blades and a casing in a gas turbine. The teachings provide for measuring the clearance during operation of the gas turbine and controlling parameters of the gas turbine in accordance with the measured clearance. The parameters are controlled in such a way as to provide greater efficiency in operation of the gas turbine than would occur without the apparatus and methods.

Generally, the clearance is measured with a sensor, which provides information related to the clearance to a control system. The control system, which may be included in a gas turbine engine controller, receives the information and controls certain parameters of the gas turbine in accordance with the information. Two examples of the parameters controlled are inlet bleed-heat air and fuel flow. Before the embodiments are discussed in detail, certain definitions are provided.

The term “gas turbine” relates to a continuous combustion engine. The gas turbine generally includes a compressor, a combustion chamber and a turbine. The compressor compresses air for combustion in a combustion chamber. The term “compressor blade” relates to a blade in the compressor. Each compressor blade has an airfoil shape used for compressing the air. The term “compressor stage” relates to a plurality of compressor blades that are circumferentially disposed about a section of a shaft. The gas turbine can include one or more compressor stages in the compressor. The term “casing” relates to a structure surrounding the compressor stages to limit air from moving around outside tips of the compressor blades. The term “clearance” relates to an amount of distance between the outside tip of one compressor blade and the casing. The term “rubbing” relates to at least one compressor blade making contact with the casing. Rubbing generally causes damage to the gas turbine. The term “inlet bleed-heat air” relates to air extracted from the compressor before the air is sent to the combustion chamber. The extracted air is generally heated from the compressing and directed to the inlet of the compressor.

The term “surge” relates to an interruption of airflow through the compressor of the gas turbine. A surge condition can cause a cessation of airflow to the combustion chamber and cause unstable operation or uncommanded shutdown of the gas turbine. During the surge condition, airflow is generally directed toward the inlet of the compressor. Surge can be farther discussed with respect to some operating parameters of the compressor. One operating parameter is “pressure ratio” (Pₑₓᵢₜ/Pᵢₙₗₑₜ), which is the ratio of exit pressure of the compressor to inlet pressure of the compressor. Another operating parameter is “compressor airflow,” which is the amount of air flowing through the compressor. Certain combinations of the pressure ratio and the compressor airflow can describe conditions that can lead to or cause a surge condition in a gas turbine. These combinations can be represented in a number of ways such as a table, a data set, and an algorithm for example. One common representation uses a map or graph of pressure ratio versus compressor airflow.

The terms “surge line” and “operating limit line” relate to lines on the graph of pressure ratio versus compressor airflow. The surge line represents the operating limit above which operation of the gas turbine would lead to or cause the gas turbine to experience a surge condition. The operating limit line refers to the control limit of the gas turbine to ensure sufficient margin is maintained to the surge line. The clearance can be a factor in determining the operating parameters that can cause the surge condition. For example, in some gas turbines if an amount of clearance decreases during operation, then the margin to the surge line may increase. In general, operating the gas turbine with operating conditions on the operating limit line(i.e., margin to the surge line) prevents the surge condition from occurring.

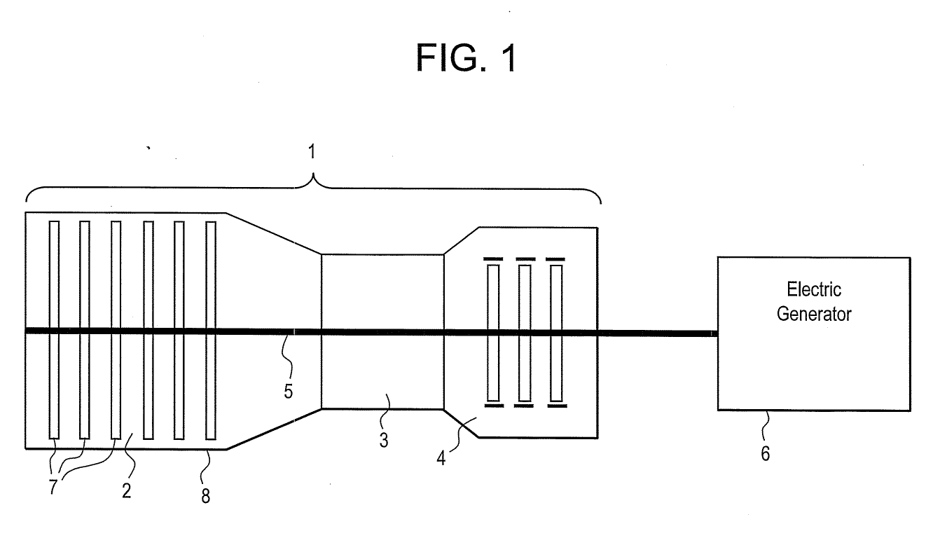

FIG. 1 illustrates an exemplary embodiment of a gas turbine 1. The gas turbine 1 includes a compressor 2, a combustion chamber 3, and a turbine 4. The compressor 2 is coupled to the turbine 4 by a shaft 5. In the embodiment of FIG. 1, the shaft 5 is also coupled to an electric generator 6. The turbine 4 includes compressor stages 7, and a casing 8. The compressor 2 is described in more detail next.

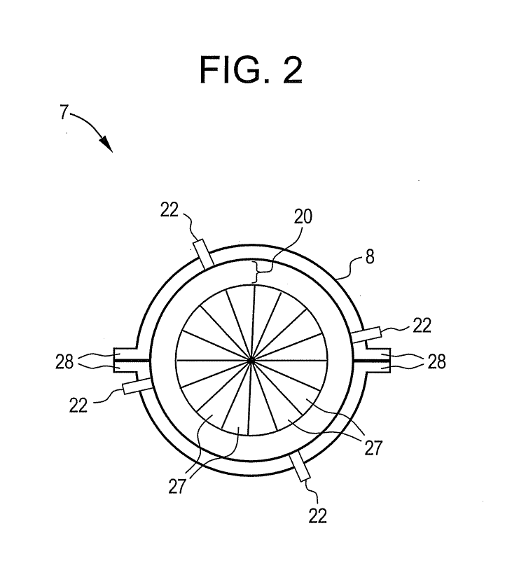

FIG. 2 illustrates an end view of an exemplary embodiment of one compressor stage 7 of the compressor 2. Referring to FIG. 2, a clearance 20 is illustrated. The casing 8 depicted in FIG. 2 includes two 180-degree segments coupled together by flanges 28. The casing 8 shown in FIG. 2 encloses a plurality of compressor blades 27 by about 360 degrees. FIG. 2 also depicts a plurality of sensors 22 disposed about the casing 8. The sensors 22 are used to measure the clearance 20.

The sensors 22 are generally disposed circumferentially about the casing 8 to measure certain aspects related to the clearance 20. For example, the clearance 20 in one area of the compressor stage 7 may be greater than in another area due to bearing movement. Bearing movement resulting from bearing wear and manufacturing tolerances can allow the shaft 5 to move. As another example, circumferential measurements provide for detecting when the casing 8 is out-of-round. Generally, the sensors 22 are located near and away from the flanges 28. Because the casing 8 generally has more mass near the flanges 28, the casing 8 may be out-of-round until the casing 8 is uniformly heated. The sensors 22 may also measure the clearance 20 at other compressor stages 7.

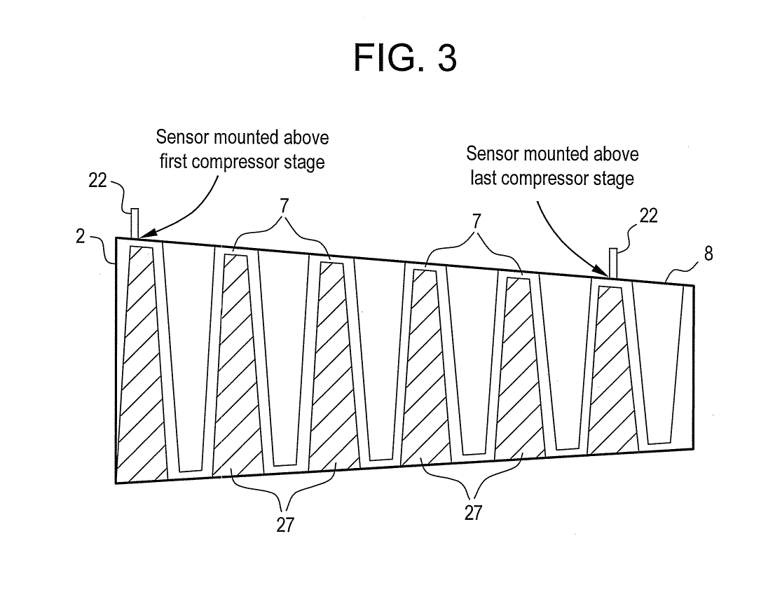

Measuring the clearance 20 at more than one compressor stage 7 can provide for detecting at least one of sag and bounce of the shaft 5. FIG. 3 is a side view of an exemplary embodiment of the compressor 2. Referring to FIG. 3, sensors 22 are disposed above a first compressor stage 7 and above a last compressor stage 7 in order to measure any sag or bounce of the shaft 5.

In general, the sensors 22 can measure distances up to at least 0.762 cm (0.3 inches). The sensors 22 can use different techniques as is known in the art of clearance sensing to measure the clearance 20. In one embodiment, the sensor 22 is a capacitance probe that relates capacitance to the clearance 20 as is known in the art of capacitance sensing. The capacitance probe measures the capacitance of a capacitor formed by the probe and the surrounding air as a dielectric. The compressor blades 27 moving through the air near the probe affect the capacitance of the capacitor. The measured capacitance is correlated to the clearance 20. These sensors 22 are available as PYROTENAX sensors from Tyco Thermal Controls LLC of Menlo Park, Calif. In another embodiment, the sensor 22 is a microwave probe that uses microwaves to measure the clearance 20. As is known in the art of microwave sensing, the microwave probe emits microwaves that can be used to measure motions or obstructions. The motions and obstructions measured can be correlated to the clearance 20. These sensors 22 are available from Endevco Corporation of San Juan Capistrano, Calif.

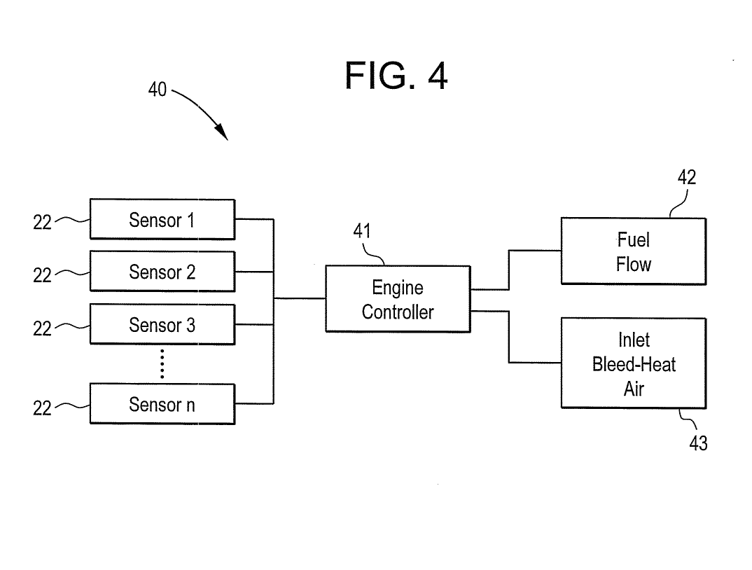

The sensors 22 provide information that is used to control certain parameters of the gas turbine 1. FIG. 4 illustrates an exemplary embodiment of a control system 40 for the gas turbine 1. The control system 40 includes “n” sensors 22. The “n” sensors 22 provide clearance information to a gas turbine engine controller 41. In the non-limiting embodiment of FIG. 4, the gas turbine engine controller 41 uses the clearance information to control at least one of fuel flow 42 and inlet bleed-heat air 43. In other embodiments, the gas turbine engine controller 41 can also control other parameters of the gas turbine 1 to prevent at least one of the surge condition and rubbing of the blades. In other embodiments, the gas turbine engine controller 41 can control devices not part of the gas turbine 1 but related to the gas turbine 1 such that control of the devices can prevent at least one of the surge condition and rubbing of the blades.

During start-up, the control system 40 can increase a flow rate of the fuel flow 42 to decrease the time to full power operation. The control system 40 can increase the flow rate by monitoring the clearance 20 to ensure that an adequate amount of the clearance 20 exists. The control system 40 can also improve efficiency of the gas turbine 1 during part power operation.

Generally, the inlet bleed-heat air 43 is used during part power operation to ensure sufficient margin to the surge line. Use of the inlet bleed-heat 43 decreases the efficiency of the gas turbine 1 because all of the air that is compressed is not used for combustion. The control system 40 can allow operation with reduced margin (i.e. operating limit line with less margin to the surge line) and delay activation of the inlet bleed-heat air 43 by determining that a proper amount of the clearance 20 exists. The control system 40 can also provide several other advantages.

Generally, the margin from the surge line to the operating limit line may be increased to account for degradation associated with the aging of the gas turbine 1. The control system 40 can determine if degradation is affecting the clearance 20. If degradation is not affecting the clearance 20, then the control system 40 may operate the gas turbine 1 without an increased margin to the surge line. The control system 40 may provide for increased power output from the gas turbine 1 to meet increased demand.

The gas turbine 1 may be used to turn the electric generator 6 to provide power to a grid system. Generally, merchant power suppliers connected to the grid system have to comply with certain standards such as a grid code. The grid code may require the merchant power suppliers to increase power output if the grid frequency starts to drop. The control system 40 can be used to determine if an adequate amount of the clearance 20 exists to increase the power output without increasing a risk of surge.

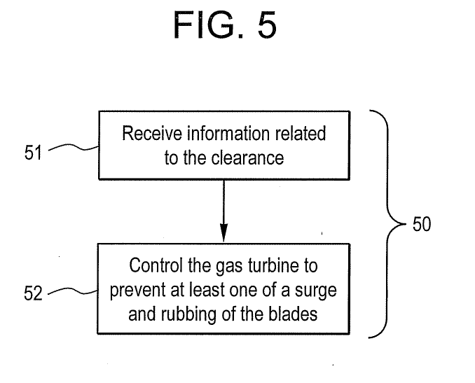

FIG. 5 presents a method 50 for controlling the gas turbine 1. The method 50 calls for receiving 51 information related to the clearance 20. The method 50 also calls for controlling 52 the gas turbine 1 to prevent at least one of a surge and rubbing of the blades.

Various components may be included and called upon for providing for aspects of the teachings herein. For example, the gas turbine engine controller 41 may include at least one of an analog system and a digital system. The digital system may include at least one of a processor, memory, storage, input/output interface, input/output devices, and a communication interface. In general, a computer program product stored on machine-readable media and including machine executable instructions can be input to the digital system. The computer program product may include instructions that can be executed by the processor for monitoring the clearance 20 and controlling the gas turbine 1 to prevent at least one of a surge and rubbing of the compressor blades 27. The various components may be included in support of the various aspects discussed herein or in support of other functions beyond this disclosure.

The technical effect of the computer program product is to increase the efficiency of the gas turbine 1 and prevent an increased risk of surge.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A gas turbine comprising a compressor, the gas turbine comprising:
a sensor for measuring a clearance of blades in the compressor; and
a controller for receiving clearance information and using the information to control the gas turbine for prevention of at least one of a surge and rubbing of the blades.

2. The gas turbine as in claim 1, wherein the controller controls at least one of fuel flow to the gas turbine and inlet bleed-heat air to the compressor.

3. The gas turbine as in claim 1, wherein the sensor is at least one of a capacitance probe and a microwave probe.

4. The gas turbine as in claim 1, wherein the sensor detects at least one of bearing movement, a casing out of round, sagging of a shaft, and bouncing of the shaft.

5. A gas turbine comprising a compressor, the gas turbine comprising:
a plurality of sensors for measuring clearances of blades in the compressor; and
a controller for receiving clearance information and using the information to control at least one of fuel flow to the gas turbine and inlet bleed-heat air to the compressor for prevention of at least one of a surge and rubbing of the blades.

6. A method for controlling a gas turbine comprising a compressor, the method comprising:
receiving information related to a clearance of blades in the compressor; and
controlling the gas turbine to prevent at least one of a surge and rubbing of the blades.

7. The method as in claim 6, wherein controlling comprises at least one of controlling fuel flow to the gas turbine and controlling inlet bleed-heat air to the compressor.

8. The method as in claim 6, further comprising detecting at least one of bearing movement, a casing out of round, sagging of a shaft, and bouncing of the shaft.

9. The method as in claim 6, further comprising indicating a margin to a surge condition.

10. The method as in claim 6, further comprising indicating an amount of additional power the gas turbine is capable of producing without an additional risk of surge.

11. The method as in claim 6, wherein the method is implemented by a computer program product stored on machine-readable media and comprising machine executable instructions for operating a gas turbine comprising a compressor, the product comprising instructions for:
receiving information related to a clearance of blades in the compressor; and
controlling the gas turbine to prevent at least one of a surge and rubbing of the blades.
